(19) United States
(12) Patent Application Publication
(10) Pub. No.: US 2019/0275819 A1
(43) Pub. Date: Sep. 12, 2019

(54) REVERSIBLE RECORDING MEDIUM AND EXTERIOR MEMBER

(71) Applicant: Sony Corporation, Tokyo (JP)

(72) Inventors: Yuriko Kaino, Kanagawa (JP); Kenichi Kurihara, Kanagawa (JP); Aya Shuto, Kanagawa (JP); Ryo Kasegawa, Kanagawa (JP)

(73) Assignee: Sony Corporation, Tokyo (JP)

(21) Appl. No.: 16/348,915

(22) PCT Filed: Oct. 17, 2017
(86) PCT No.: PCT/JP2017/037530

§ 371 Date: May 10, 2019

(30) Foreign Application Priority Data
Nov. 18, 2016 (JP) 2016-225356

(51) Int. Cl. B41M 5/30; B41M 5/46; B41M 5/36

(52) U.S. Cl. CPC B41M 5/305; B41M 5/363; B41M 5/46

(57) ABSTRACT

A reversible recording medium of an embodiment of the present disclosure includes a support base and a recording layer. The recording layer is provided on the support base and reversibly changes between a recorded state and a deleted state. A chroma difference ΔC* between the support base and the recording layer satisfies the relational expression (1) where an absorption spectrum in a visible region of the recording layer in the deleted state and an absorption spectrum in a visible region of the support base are each denoted by L*a*b*.

### TECHNICAL FIELD

The present disclosure relates to a reversible recording medium that allows for recording and deletion of, for example, a repeated image, etc., and an exterior member provided therewith.

### BACKGROUND ART

Recently, necessity of a rewritable recording technique has been recognized from the viewpoint of global environment. For example, development has been in progress in a recording medium that enables information to be recorded and deleted reversibly by heat, i.e., a so-called reversible recording medium, as an example of a display medium that replaces a printed matter.

The reversible recording medium is configured, for example, by a coloring compound having an electron-donating property, a color developing/quenching agent having an electron-accepting property, a photothermal conversion material that absorbs light to convert the light into heat, and a matrix polymer. For example, PTL 1 discloses a reversible multicolor recording medium in which a plurality of recording layers are stacked that include reversible thermal color developing compositions having different developed color hues. The reversible recording medium enables display without color fogging, by using, for each of the recording layers, a light-heat converting composition in which an absorption peak wavelength of each of the recording layers becomes smaller in a range from 1,500 nm to 750 mn from side of a supporting substrate.

### CITATION LIST

### Patent Literature

PTL 1: Japanese Unexamined Patent Application Publication No. 2005-66936

### SUMMARY OF THE INVENTION

Incidentally, some photothermal materials with an absorption peak in a near infrared region have an absorption edge that extends up to a visible region. In a case of using such a photothermal conversion material for a recording layer, a color of the photothermal conversion material may be visually recognized in some instances in a deleted state, thus possibly lowering display quality.

It is desirable to provide a reversible recording medium and an exterior member that make it possible to enhance display quality.

A reversible recording medium according to an embodiment of the present disclosure includes a support base and a recording layer. The recording layer is provided on the support base and reversibly changes between a recorded state and a deleted state. In a case where an absorption spectrum in a visible region of the recording layer in the deleted state is denoted by Lₛ*aₛ*bₛ* and where an absorption spectrum in a visible region of the support base is denoted by L₀*a₀*b₀*, a chroma difference ΔC* between the support base and the recording layer in the deleted state satisfies the following relational expression (1).

ΔC*=((a₀*−aₛ*)²+(b₀*−bₛ*)²)≤6.5 (1)

An exterior member according to an embodiment of the present disclosure has at least one surface that is provided with the above-described reversible recording medium according to an embodiment of the present disclosure.

In the reversible recording medium and the exterior member of respective embodiments of the present disclosure, the chroma difference ΔC* between the recording layer in the deleted state and the support base satisfies the above relational expression (1). This makes it possible to make the recording layer in the deleted state less likely to be visually recognized.

According to the reversible recording medium and the exterior member of the respective embodiments of the present disclosure, the chroma difference ΔC* between the recording layer in the deleted state and the support base satisfies the above relational expression (1), thus making it possible to make the recording layer in the deleted state less likely to be visually recognized. Hence, it becomes possible to suppress a change in a tone of the support base to be observed in the deleted state and thus to enhance display quality.

It is to be noted that the effects described here are not necessarily limitative, and may be any of the effects described in the present disclosure.

### BRIEF DESCRIPTION OF DRAWINGS

FIG. 1 is a cross-sectional view of an example of a configuration of a reversible recording medium according to a first embodiment of the present disclosure.

FIG. 2 illustrates an absorption spectrum of a photothermal conversion material.

FIG. 3 is a cross-sectional view of an example of a configuration of a reversible recording medium according to a second embodiment of the present disclosure.

FIG. 4 is a cross-sectional view of an example of a configuration of a reversible recording medium according to Modification Example 1 of the present disclosure.

FIG. 5 is a cross-sectional view of an example of a configuration of a reversible recording medium according to Modification Example 2 of the present disclosure.

FIG. 6A is a perspective view of an example of an appearance of Application Example 1.

FIG. 6B is a perspective view of another example of the appearance of Application Example 1.

FIG. 7A is a perspective view of an example of an appearance of the front of Application Example 2.

FIG. 7B is a perspective view of an example of an appearance the rear of Application Example 2.

FIG. 8A is a perspective view of an example of an appearance of Application Example 3.

FIG. 8B is a perspective view of another example of the appearance of Application Example 3.

FIG. 9 is an explanatory diagram illustrating a configuration example of Application Example 4.

### MODES FOR CARRYING OUT THE INVENTION

In the following, some embodiments of the present disclosure are described in detail with reference to the drawings. It is to be noted that the following description is directed to specific examples of the present disclosure, and the present disclosure is not limited to the following embodiments. The description is given in the following order.

1. First Embodiment (An example of a reversible recording medium including a single-layer recording layer)

### 1-1. Configuration of Reversible Recording Medium

### 1-2. Manufacturing Method of Reversible Recording Medium

### 1-3. Recording and Deletion Methods of Reversible Recording Medium

### 1-4. Workings and Effects

2. Second Embodiment (An example of a reversible recording medium in which a plurality of recording layers having different developed color hues are stacked)

### 2-1. Configuration of Reversible Recording Medium

### 2-2. Recording and Deletion Methods of Reversible Recording Medium

### 2-3. Workings and Effects

### 3. Modification Examples

3-1. Modification Example 1 (An example of a reversible recording medium that enables multicolor display using a single-layer recording layer)
3-2. Modification Example 2 (An example of a reversible recording medium in which a plurality of recording layers having different color-developing sensitivity are stacked)

### 3-2-1. Configuration of Reversible Recording Medium

### 3-2-2. Workings and Effects

### 4. Application Examples

### 5. Working Examples

### 1. First Embodiment

FIG. 1 illustrates a cross-sectional configuration of a reversible recording medium (a reversible recording medium 1) according to a first embodiment of the present disclosure. The reversible recording medium 1 includes, for example, a recording layer 12 that is disposed on a support base 11 and allows for reversible change between a recorded state and a deleted state. A protective layer 13 is provided on the recording layer 12. It is to be noted that FIG. 1 schematically illustrates the cross-sectional configuration of the reversible recording medium 1 and that the size and shape thereof may be different from the actual size and shape thereof in some cases.

### (1-1. Configuration of Reversible Recording Medium)

The support base 11 serves to support the recording layer 12. The support base 11 is configured by a material having superior heat resistance as well as superior size stability in a planar direction. The support base 11 may have a property of either light-transmissivity or light reflectivity. For example, the support base 11 either may be a substrate having rigidity, such as a wafer, or may be configured by flexible thin layer glass, film, paper, or the like. The use of a flexible substrate as the support base 11 allows for achievement of a flexible (foldable) reversible recording medium.

Examples of a constituent material of the support base 11 include an inorganic material, a metal material, and a macromolecular material such as plastic. Specific examples of the inorganic material include silicon (Si), silicon oxide (SiOx), silicon nitride (SiNx), and aluminum oxide (AlOx). Examples of silicon oxide include glass and spin-on-glass (SOG). Examples of the metal material include aluminum (Al), nickel (Ni), and stainless steel. Examples of the macromolecular material include polycarbonate (PC), polyethylene terephthalate (PET), polyethylene naphthalate (PEN) or polyethyl ether ketone (PEEK), polyvinyl chloride (PVC), and copolymers thereof.

It is to be noted that an upper surface or a lower surface of the support base 11 may be provided with a reflective layer (unillustrated). The provision of the reflective layer allows for more vivid color display.

The recording layer 12 enables information to be recorded and deleted reversibly by heat. The recording layer 12 is configured by a material that allows for stable repeated recording and allows for control of a decolored state and a color-developed state. Specifically, the recording layer 12 includes a coloring compound, a color developing/quenching agent, and a photothermal conversion material, and is formed, for example, by a macromolecular material. The recording layer 12 has a thickness in a range from 1 μm to 10 μm, for example.

Examples of the coloring compound include a leuco pigment. Examples of the leuco pigment include existing dye for heat-sensitive paper. A specific example thereof includes a compound that contains, in a molecule, a group having an electron-donating property and is represented by the following formula (1).

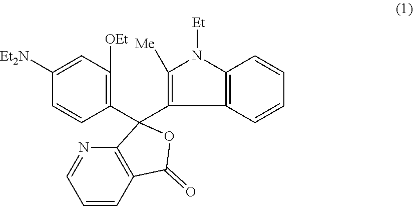

The color developing/quenching agent serves, for example, to develop a color of a colorless coloring compound or to decolor a coloring compound colored in a predetermined color. Examples of the color developing/quenching agent include a phenol derivative, a salicylic acid derivative, and a urea derivative. Specific examples thereof include a compound having a salicylic acid skeleton represented by the following general formula (2) and containing, in a molecule, a group having an electron-accepting property.

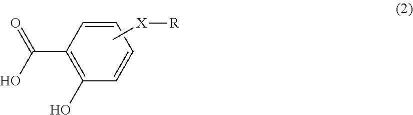

(X is one of —NHCO—, —CONH—, —NHCONH—, —CONHCO—, —NHNHCO—, —CONHNH—, —CONHNHCO—, —NHCOCONH—, —NHCONHCO—, —CONHCONH—, —NHNHCONH—, —NHCONHNH—, —CONHNHCONH—, —NHCONHNHCO—, and —CONHNHCONH—. R is a linear hydrocarbon group having 25 to 34 carbon atoms.)

The photothermal conversion material serves, for example, to absorb light in a predetermined wavelength region of a near infrared region to generate heat. It is preferable to use, as the photothermal conversion material, for example, a near infrared-absorbing pigment that has an absorption peak in a wavelength in a range from 700 nm to 2,000 nm and hardly has an absorption in a visible region. Specific examples thereof include a compound having a phthalocyanine skeleton (a phthalocyanine-based dye), a compound having a squarylium skeleton (a squarylium-based dye), a compound having a naphthalocyanine skeleton, a compound having a croconium skeleton, a metal complex such as a dithio complex and a thiolate complex, a diimmonium salt, an iminium salt, an aminium salt, and an inorganic compound. Examples of the inorganic compound include metal oxides such as graphite, carbon black, metal powder particles, tricobalt tetroxide, iron oxide, chromium oxide, copper oxide, titanium black and ITO, metal nitrides such as niobium nitride, metal carbides such as tantalum carbide, metal sulfides, and various magnetic powders. Aside from those described above, a compound having a cyanine skeleton (a cyanine-based dye) with superior light resistance and superior heat resistance may be used. As used herein, the superior light resistance refers to not dissolving during laser irradiation. The superior heat resistance means that a change equal to or more than 20% does not occur to a maximum absorption peak value of an absorption spectrum when being formed as a film together with a macromolecular material, for example, and being stored at 150° C. for 30 minutes, for example. Examples of such a compound having a cyanine skeleton include a compound containing, in a molecule, one or both of a counter ion of one of SbF₆, PF₆, BF₄, ClO₄, CF₃SO₃ and (CF₃SO₃)₂N and a methine chain containing a five-membered ring or a six-membered ring. It is to be noted that, although the compound having a cyanine skeleton to be used for the reversible recording medium according to the present embodiment is preferably provided with both of one of the above-mentioned counter ions and the ring structure such as a five-membered ring and a six-membered ring in a methine chain, the provision of at least one of those allows sufficient light resistance and heat resistance to be secured.

It is to be noted that a material with superior light resistance and superior heat resistance does not dissolve during laser irradiation, as described above. Examples of a way to confirm the superior light resistance include a method of measuring a peak change in an absorption spectrum at the time of a xenon lamp irradiation test. When a change rate is 20% or less at the time of irradiation for 30 minutes, it is possible to judge that light resistance is favorable. Examples of a way to confirm the superior heat resistance include a method of measuring a peak change in an absorption spectrum at the time of storing at 150° C. When a change rate is 20% or less after the 30-minute test, it is possible to judge that heat resistance is favorable.

As the macromolecular material, it is preferable to adopt a material in which the coloring compound, the color developing/quenching agent, and the photothermal conversion material are easily dispersed evenly. As the macromolecular material, for example, a matrix resin is preferably used; examples thereof include a thermosetting resin and a thermoplastic resin. Specific examples thereof include polyvinyl chloride, polyvinyl acetate, a vinyl chloride-vinyl acetate copolymer, ethyl cellulose, polystyrene, a styrene-based copolymer, a phenoxy resin, polyester, aromatic polyester, polyurethane, polycarbonate, a polyacrylic ester, a polymethacrylic ester, an acrylic-based copolymer, a maleic acid-based polymer, polyvinyl alcohol, modified polyvinyl alcohol, hydroxy ethyl cellulose, carboxymethyl cellulose, and starch.

The recording layer 12 includes at least one of the coloring compounds, at least one of the color developing/quenching agents, and at least one of the photothermal conversion materials. The recording layer 12 may include, in addition to the above-mentioned materials, various additives such as a sensitizer and an ultraviolet absorbing agent, for example.

The recording layer 12 in the present embodiment is configured to allow a chroma difference (ΔC*) between the support base 11 and the recording layer 12 in a deleted state to satisfy the following relational expression (1) in a case where an absorption spectrum in a visible region of the recording layer 12 in the deleted state is denoted by Lₛ*aₛ*bₛ* and where an absorption spectrum in a visible region of the support base 11 is denoted by L₀*a₀*b₀*. Here, the visible region is set in a range from 380 nm to 780 nm.

ΔC*=((a₀*−aₛ*)²+(b₀*−bₛ*)²)≤6.5 (1)

Further, a color difference (ΔE*) between the support base 11 and the recording layer 12 in the deleted state preferably satisfies the following relational expression (2).

ΔE*=√((L₀*−Lₛ*)²+(a₀*−aₛ)²+(b₀*−bₛ*)²)≤6.5 (2)

By configuring the recording layer 12 to satisfy the above relational expression (1) or/and relational expression (2), it becomes possible to make the recording layer 12 in the deleted state less likely to be visually recognized. In other words, it becomes possible to exhibit to a user a color of the support base 11 itself, with the recording layer 12 being in the deleted state. More preferably, it is desirable for the recording layer 12 to satisfy the following relational expression (3) or/and the following relational expression (4). Accordingly, it becomes possible to make the recording layer 12 in the deleted state still less likely to be visually recognized.

ΔC*=((a₀*−aₛ*)²+(b₀*−bₛ*)²)≤3.2 (3)

ΔE*=√((L₀*−Lₛ*)²+(a₀*−aₛ)²+(b₀*−bₛ*)²)≤3.2 (4)

The protective layer 13 serves to protect a surface of the recording layer 12, and is formed using an ultraviolet curable resin or a thermosetting resin, for example. The protective layer 13 has a thickness in a range from 0.1 μm to 100 μm, for example.

### (1-2. Manufacturing Method of Reversible Recording Medium)

The reversible recording medium 1 according to the present embodiment may be manufactured using an application method, for example. It is to be noted that the manufacturing method described below is merely exemplary; any other method may be used for the manufacture.

First, for example, a vinyl chloride/vinyl acetate copolymer is dissolved as a macromolecular material into a solvent (e.g., methyl ethyl ketone). A coloring compound, a color developing/quenching agent, and a photothermal conversion material are added to the solution, and dispersed therein. This allows for obtainment of a reversible recording medium coating. Subsequently, the reversible recording medium coating is applied onto the support base 11 to have a predetermined thickness, and is dried at 70° C., for example, to form the recording layer 12.

Subsequently, an acrylic resin, for example, is applied onto the recording layer 12 to have a thickness of 10 m, for example, and thereafter is dried to form the protective layer 13. The above allows for completion of the reversible recording medium 1 illustrated in FIG. 1.

It is to be noted that a method other than the above-described application may be used to form the recording layer 12. For example, a film obtained by application to another base material beforehand may be adhered onto the support base 11 via an adhesive film, for example, to form the recording layer 12. Alternatively, the support base 11 may be immersed in the coating to form the recording layer 12.

### (1-3. Recording and Deletion Methods of Reversible Recording Medium)

In the reversible recording medium 1, recording and deletion may be performed as follows, for example.

First, the recording layer 12 is heated at a temperature enough to decolor a coloring compound to cause the recording layer 12 to be in a decolored state (deleted state) in advance. Next, a desired position of the recording layer 12 is irradiated with a near infrared ray having a wavelength and an output that are adjusted using, for example, a semiconductor laser, etc. This allows for heat generation of the photothermal conversion material included in the recording layer 12, causing a coloring reaction (chromogenic reaction) between the coloring compound and the color developing/quenching agent, thus allowing the irradiated part to develop a color.

Meanwhile, in a case where a color-developed part is decolored, irradiation is performed with a near infrared ray at energy enough to cause the color-developed part to reach a decoloring temperature. This allows for heat generation of the photothermal conversion material included in the recording layer 12, causing a decoloring reaction between the coloring compound and the color developing/quenching agent, thus allowing the irradiated part to be decolored and leading to deletion of a record. Further, in a case of deleting all of records formed in the recording layer 12 all at once, the reversible recording medium 1 is heated at a temperature enough to perform decoloring. This allows information recorded in the recording layer 12 to be deleted all at once. Thereafter, the above-described operation is performed, thus enabling repeated recording into the recording layer 12.

It is to be noted that the color-developed state and the decolored state are kept insofar as the above-described chromogenic reaction and decoloring reaction such as the near infrared irradiation and the heating are not performed.

### (1-4. Workings and Effects)

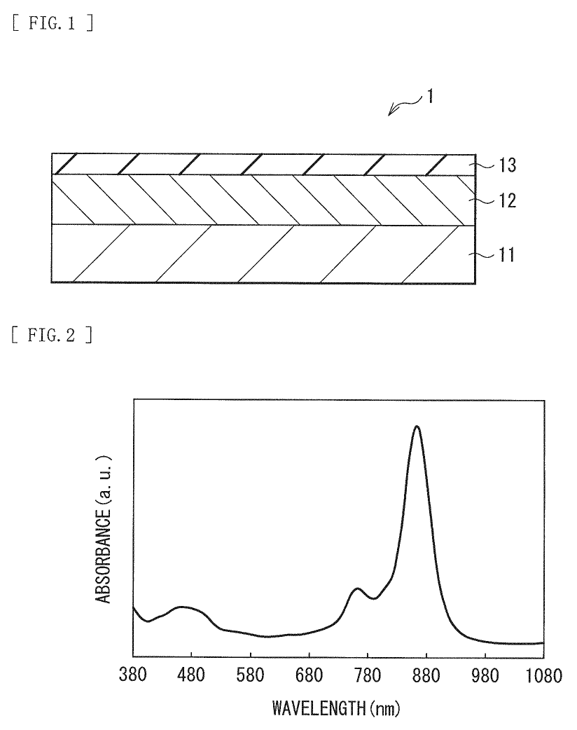

As described above, the semiconductor laser, for example, is used for writing into and deletion from the reversible recording medium. Laser light used to irradiate the reversible recording medium is absorbed by the photothermal conversion material, and is converted into heat. The photothermal conversion material has a main absorption in a near infrared region, and an absorption wavelength thereof extends up to a visible region as illustrated in FIG. 2. In a case where the absorption of the photothermal conversion material is present in the visible region, a color thereof may be sensed by the naked eye in some instances.

In particular, in a reversible recording medium that enables multicolor display, in which a plurality of recording layers are stacked that includes respective coloring compounds having different developed color hues, it is desirable, for a region not in a color-developed state of each of the recording layers, to be colorless and transparent in order to prevent color mixture with a layer in a color-developed state and in order to allow a color of a support substrate on which the recording layers are formed to look clear. Accordingly, it is desirable that absorption of a wavelength in a visible region performed by the photothermal conversion material not be sensed by human eyes.

In contrast, in the present embodiment, the chroma difference (ΔC*) between the recording layer 12 in a deleted state and the support base 11 satisfies the above relational expression (1). Accordingly, it becomes possible to make the recording layer 12 in the deleted state less likely to be visually recognized.

Examples of a method of expressing a color of an object by quantification include CIE L*a*b* display system. L* denotes lightness, and a*b* denotes chromaticity indicating a color hue and chroma. a*b* denotes a direction of a color; a* denotes a red direction, −a* denotes a green direction, b* denotes a yellow direction, and −b* denotes a blue direction. As L* becomes larger, a color becomes more vivid. As a numerical value becomes smaller, a color becomes more somber. For example, in a case where a certain color 0 is expressed by (L₀*a₀*b₀*) and where a certain color 1 is expressed by (L₁*a₁*b₁*), a color difference ΔE* between the two colors is able to be calculated by the following expressions.

ΔL*=(L₀*−L₁*)

Δa*=(a₀*−a₁*)

Δb*=(b₀*−b₁*)

ΔE*=(ΔL*²+Δa*²+Δb*²)^{0.5}

Table 1 lists standard handling of color difference to be used in general industrial applications. It follows from Table 1 that, when ΔE*≤6.5, more preferably, ΔE*≤3.2 holds true, the color difference is at such a level as to be hardly recognized. Accordingly, also in the recording layer including a plurality of stacked layers to which the photothernal conversion material is added, setting a value of ΔE* between layers to ΔE*≤6.5, more preferably, ΔE*≤3.2 makes the recording layer in the deleted state less likely to be visually recognized. Further, in a case where layers are overlaid, by adjusting an amount of addition of the photothermal conversion material in each of the layers to ΔE*≤6.5, more preferably, ΔE*≤3.2 as a result of tones canceling each other, a tone of the photothermal conversion material is not sensed by the naked eye.

TABLE 1

| | Range of Color | |
|---|---|---|
| | Difference ΔE* | Level of Color Difference Perceived |
| Unevaluable Region | 0-0.2 | Within a margin of error even with a specially-adjusted |
| | | color-measuring machine; unidentifiable by a person. |
| Identification Limit | 0.2-0.4 | Within a range of reproducing accuracy of a |
| | | fully-adjusted color-measuring machine; a limit at |
| | | which a well-trained person is able to perform |
| | | identification with reproducibility. |
| Class AAA | 0.4-0.8 | Limit at which a standard of strict tolerance is able to be |
| Tolerance | | set in terms of reproducibility of visual determination. |
| Class AA Tolerance | 0.8-1.6 | Level at which a slight color difference is felt in |
| | | comparison between adjacent colors. |
| | | Level at which colors are generally regarded as the |
| | | same color. |
| Class A Tolerance | 1.6-3.2 | Level at which a color difference is hardly noticed in |
| | | comparison between separate colors. |
| | | Level at which colors are generally regarded as the |
| | | same color. |
| Class B Tolerance | 3.2-6.5 | Range in which colors are handled as the same color at |
| | | an impression level. In industrial fields of coating and |
| | | plastic, a claim for different color may occur in some |
| | | cases. |
| Class C Tolerance | 6.5-13.0 | A color difference corresponding to a single rate in |
| | | color charts such as JIS standard color chart and |
| | | Munsell color chart. |
| Class D Tolerance | 13.0-25.0 | Such a difference in colors as to be distinguishable by |
| | | segmentalized color system names; when exceeding this |
| | | level, the color has another color image. |

It is to be noted that in a case where lightness (L*) of the support base 11 and lightness (L*) of the recording layer 12 are the same, ΔE*=ΔC* holds true. For example, in a case where L₀* of the support base 11 is small, it follows that Lₛ* of the recording layer 12 is small. As used herein, the phrase “Lₛ* is small” means that the recording layer 12 has low transparency. In a case where it is desired that the color of the support base 11 be shown, it is better for Lₛ* to be larger. In that case, ΔL* becomes larger, thus causing ΔE* to be larger as well. In reality, when there is no difference between a₀*b₀* of the support base 11 and aₛ*bₛ* of the recording layer 12, no difference in a color tone is felt. Accordingly, in order for the color tone of the recording layer 12 not to be visually recognized regardless of L* of the support base 11, it is sufficient to have ΔC*≤6.5, more preferably, ΔC*≤3.2. Further, in a case where L₀* of the support base 11 is large, it is sufficient to have smaller lightness difference ΔL* between the support base 11 and the recording layer 12, and thus to have ΔE*≤6.5, more preferably, ΔC*≤3.2.

As described above, in the reversible recording medium 1 of the present embodiment, the chroma difference (ΔC*) between the recording layer 12 in the deleted state and the support base 11 satisfies the above relational expression (1), thereby making the recording layer 12 in the deleted state less likely to be visually recognized. Thus, it becomes possible to suppress a change in the tone of the support base 11 in the deleted state. Further, a boundary between a region in a recorded state and a region in a deleted state becomes definite, thus achieving high definition. Hence, it becomes possible to enhance display quality of the reversible recording medium 1.

Next, description is given of a second embodiment and Modification Examples 1 and 2 of the present disclosure. In the following, components similar to those of the foregoing first embodiment are denoted by the same reference numerals, and descriptions thereof are omitted where appropriate.

### 2. Second Embodiment

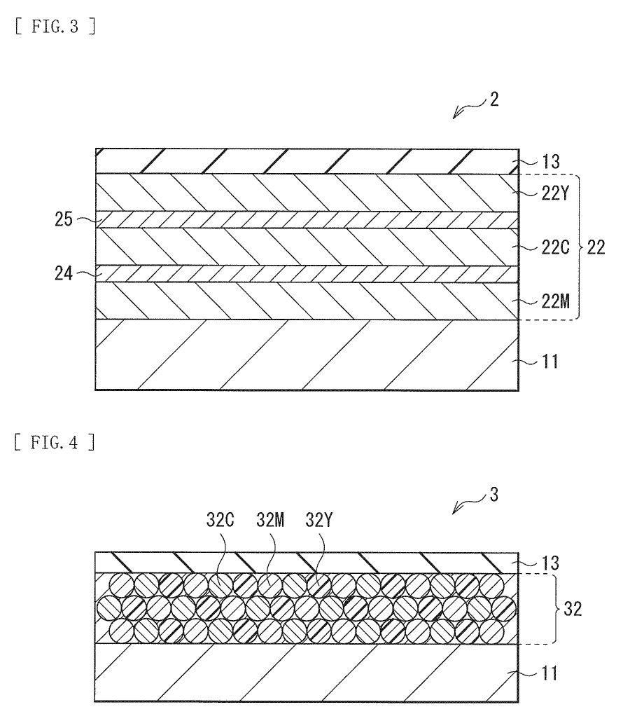

FIG. 3 illustrates a cross-sectional configuration of a reversible recording medium (a reversible recording medium 2) according to a second embodiment of the present disclosure. Similarly to the foregoing first embodiment, the reversible recording medium 2 includes a recording layer 22 that is disposed on the support base 11 and allows for reversible change between a recorded state and a deleted state. The recording layer 22 has a configuration in which a plurality of layers (a first layer to an n-th layer) are stacked. In the present embodiment, the recording layer 22 has a configuration in which three layers (layers 22M, 22C, and 22Y) to be colored in different colors in color-developed states are stacked in this order. Heat-insulating layers 24 and 25 are provided, respectively, between the layers 22M and 22C and between the layers 22C and 22Y. It is to be noted that FIG. 3 schematically illustrates the cross-sectional configuration of the reversible recording medium 2 and that the size and shape thereof may be different from the actual size and shape thereof in some cases. Further, a stacking order of the layers 22M, 22C, and 22Y that configure the recording layer 22 of the present embodiment is exemplary, and is not limited to the above-described stacking order.

### (2-1. Configuration of Reversible Recording Medium)

The layers 22M, 22C, and 22Y include respective coloring compounds having different color hues, color developing/quenching agents corresponding to the respective coloring compounds, and photothermal conversion materials that absorb light in predetermined wavelength regions of a near infrared region, for example, to generate heat; the layers 22M, 22C, and 22Y are each formed by a macromolecular material, for example. As described above, the color developing/quenching agent serves, for example, to develop a color of a colorless coloring compound or to decolor a coloring compound colored in a predetermined color. As described above, the color developing/quenching agent is selected from derivatives such as a phenol derivative, a salicylic derivative, and a urea derivative; for the layers 22M, 22C, and 22Y, the color developing/quenching agents corresponding to the respective coloring compounds used for the layers are selected. As described above, the photothermal conversion material is selected from dyes such as the phthalocyanine-based dye, the cyanine-based dye, a metal complex dye, and a diimmonium-based dye; for the layers 22M, 22C, and 22Y, the photothermal conversion materials absorbing wavelengths (k) in a near infrared region of different wavelength regions to generate heat are used.

Specifically, the layer 22M includes, for example, a coloring compound that develops a magenta color, a color developing/quenching agent corresponding to the coloring compound, and a photothermal conversion material that absorbs an infrared ray of a wavelength λ₁, for example, to be colored. The layer 22C includes, for example, a coloring compound to be colored in a cyan color, a color developing/quenching agent corresponding to the coloring compound, and a photothermal conversion material that absorbs an infrared ray of a wavelength λ₂, for example, to generate heat. The layer 22Y includes, for example, a coloring compound to be colored in a yellow color, a color developing/quenching agent corresponding to the coloring compound, and a photothermal conversion material that absorbs an infrared ray of a wavelength λ₃, for example, to generate heat. This allows for obtainment of a display medium that enables full-color display.

It is to be noted that it is preferable to select, for the photothermal conversion materials to be used for the layers 22M, 22C, and 22Y, a combination of materials having narrow photoabsorption bands that do not overlap one another in a wavelength in a range from 700 nm to 2,000 nm, for example. This makes it possible to selectively color or decolor a desired layer of the layer 22M, the layer 22C, and the layer 22Y.

The layer 22M, the layer 22C, and the layer 22Y each have a thickness preferably in a range from 1 m to 20 m, for example, and more preferably in a range from 2 m to 15 m, for example. One reason for this is that, when the layers 22M, 22C, and 22Y each have a thickness less than 1 m, there is a possibility that sufficient color development density may not be obtained. Further, another reason for this is that, when the layers 22M, 22C, and 22Y each have a thickness more than 20 m, there is a possibility that a color-developing property and a decoloring property may be deteriorated due to larger amount of heat utilization of each of the layers 22M, 22C, and 22Y.

Further, similarly to the above-described recording layer 12, the layer 22M, the layer 22C, and the layer 22Y each include, in addition to the above-mentioned materials, various additives such as a sensitizer and an ultraviolet absorbing agent, for example.

Further, similarly to the foregoing first embodiment, the recording layer 22 of the present embodiment is configured to allow a chroma difference (ΔC*) between the support base 11 and the recording layer 12 in a deleted state to satisfy the above relational expression (1) or/and relational expression (2) in a case where an absorption spectrum in a visible region of the entire recording layer 22, including the layer 22M, the layer 22C, and the layer 22Y, in the deleted state is denoted by Lₛ*aₛ*bₛ* and where an absorption spectrum in a visible region of the support base 11 is denoted by L₀*a₀*b₀*. Here, the visible region is set in a range from 380 nm to 780 nm. More preferably, it is desirable that the recording layer 22 satisfy the above relational expression (3) or/and relational expression (4).

The photothermal conversion materials to be used for the layer 22M, the layer 22C, and the layer 22Y are selected as follows, for example. First, a film with the photothermal conversion material having an arbitrary concentration having been added is produced, and an absorption spectrum thereof is measured. Subsequently, a value of L*a*b* is calculated from the absorption spectrum. Next, three types of the photothermal conversion materials are selected to allow absorption peaks and absorption sub-peaks to overlap one another less. Subsequently, the absorption spectra of the selected three types of the photothermal conversion materials are overlapped to set a single absorption spectrum, and a value of L*a*b* of the spectrum is calculated. At this occasion, respective concentrations of addition are adjusted to cause each of a* and b* to be less than √3.2. It is to be noted that a* and b* move in a direction of developing a color more strongly when the concentration of addition is made higher. Finally, an actual film (the recording layer 22 including the layer 22M, the layer 22C, and the layer 22Y) is produced to measure the absorption spectrum and to measure L*a*b*. At this occasion, as for the recording layer 22, a film is formed on a substrate of transparent polyethylene terephthalate (PET), and the formed film is placed on a white plate for measurement. The white plate is set to have L*=95.

The heat-insulating layers 24 and 25 (intermediate layers) are each configured, for example, using a typical macromolecular material having translucency. Specific examples of the material include polyvinyl chloride, polyvinyl acetate, a vinyl chloride-vinyl acetate copolymer, ethyl cellulose, polystyrene, a styrene-based copolymer, a phenoxy resin, polyester, aromatic polyester, polyurethane, polycarbonate, a polyacrylic ester, a polymethacrylic ester, an acrylic-based copolymer, a maleic acid-based polymer, polyvinyl alcohol, modified polyvinyl alcohol, hydroxy ethyl cellulose, carboxymethyl cellulose, and starch; a material different from a matrix material included in the recording layer 22 is selected. It is to be noted that the heat-insulating layers 24 and 25 may each include various additives such as an ultraviolet absorbing agent, for example.

Further, the heat-insulating layers 24 and 25 may be each formed using an inorganic material having translucency. For example, use of porous silica, porous alumina, porous titania, porous carbon, a composite thereof, or the like brings preferable effects such as lower thermal conductivity as well as a higher heat-insulating effect. The heat-insulating layers 24 and 25 may be formed by a sol-gel method, for example.

The heat-insulating layers 24 and 25 each have a thickness preferably in a range from 3 m to 100 m, for example, and more preferably in a range from 5 m to 50 m, for example. One reason for this is that, when the heat-insulating layers 24 and 25 each have a too small thickness, a sufficient heat-insulating effect is not obtained, and, when having a too large thickness, thermal conductivity is deteriorated and translucency is lowered upon uniformly heating the entire reversible recording medium 2.

### (2-2. Recording and Deletion Methods of Reversible Recording Medium)

It is possible for the reversible recording medium 2 according to the present embodiment to perform recording and deletion as follows, for example. It is to be noted that description is given here of the recording layer 22 by exemplifying a case where the layer 22M to be colored in a magenta color, the layer 22C to be colored in a cyan color, and the layer 22Y to be colored in a yellow color are stacked in this order.

First, heating is performed at a temperature enough to cause the recording layer 22 (the layer 22M, the layer 22C, and the layer 22Y) to be decolored, e.g., at a temperature of 120° C., and causes the recording layer 22 to be in a decolored state in advance. Next, an arbitrary part of the recording layer 22 is irradiated with an infrared ray having a wavelength and an output that are arbitrarily selected using, for example, a semiconductor laser, etc. Here, in a case where the layer 22M is caused to develop a color, irradiation is performed with the infrared ray of the wavelength λ₁ at energy enough to cause the layer 22M to reach a color-developing temperature. This allows for heat generation of the photothermal conversion material included in the layer 22M, causing a coloring reaction (chromogenic reaction) between the coloring compound and the color developing/quenching agent, thus allowing the irradiated part to develop the cyan color. Likewise, in a case where the layer 22C is caused to develop a color, irradiation is performed with the infrared ray of the wavelength λ₂ at energy enough to cause the layer 22C to reach a color-developing temperature. In a case where the layer 22Y is caused to develop a color, irradiation is performed with the infrared ray of the wavelength λ₃ at energy enough to cause the layer 22Y to reach a color-developing temperature. This allows for heat generation of each of the photothermal conversion materials included in the layer 22C and the layer 22Y, causing a coloring reaction between the coloring compound and the color developing/quenching agent, thus allowing the respective irradiated parts to develop the cyan color and the yellow color. In this manner, the irradiation of the respective arbitrary parts with the infrared rays of the corresponding wavelengths makes it possible to record information (e.g., a full-color image).

Meanwhile, in a case where the layer 22M, the layer 22C, and the layer 22Y subjected to the color development as described above are each decolored, irradiation is performed with the infrared rays of the respective wavelengths corresponding to the layers 22M, 22C, and 22Y at energy enough to cause the layers to reach a decoloring temperature. This allows for heat generation of each of the photothermal conversion materials included in the layer 22M, the layer 22C, and the layer 22Y, causing a decoloring reaction between the coloring compound and the color developing/quenching agent, thus allowing the irradiated part to be decolored and leading to deletion of a record. Further, in a case of deleting all of records formed in the recording layer 22 all at once, the recording layer 22 is heated at a temperature enough to decolor all of the layer 22M, the layer 22C, and the layer 22Y, e.g., at 120° C. This allows information recorded in the recording layer 22 to be deleted all at once. Thereafter, the above-described operation is performed, thus enabling repeated recording into the recording layer 22.

### (2-3. Workings and Effects)

In the reversible recording medium 2 according to the present embodiment, as the recording layer 22, for example, the three layers (the layer 22M, the layer 22C, and the layer 22Y) are formed, which include the coloring compounds to be colored in the yellow color, the magenta color, and the cyan color; the respective corresponding color developing/quenching agents; and the photothermal conversion materials having different absorption wavelengths, and the three layers are stacked on the support base 11. Further, the chroma difference (ΔC*) between the entire recording layer 22 in the deleted state and the support base 11 satisfies the above relational expression (1). This makes the layer 22M, the layer 22C, and the layer 22Y, which configure the recording layer 22, less likely to be visually recognized in the deleted state, in addition to the effects in the foregoing first embodiment. Hence, it becomes possible to prevent a change in a tone of the layer in a color-developed state (recorded state) and to enhance color reproducibility. In other words, an effect is achieved that makes it possible to enhance display quality.

### 3. Modification Examples

### 3-1. Modification Example 1

The foregoing second embodiment gives an example of providing a multilayer structure in which, as the recording layer 32, the layers (the layer 22M, the layer 22C, and the layer 22Y) to be colored in different colors are formed, with the layers being stacked. However, for example, even a single-layer structure allows for achievement of a reversible recording medium that enables full-color display

FIG. 4 illustrates a recording layer 32 that is formed, for example, by mixing produced three types of microcapsules 32C, 32M, and 32Y including respective coloring compounds to be colored in different colors (e.g., cyan color (C), magenta color (M), and yellow color (Y)), respective color developing/quenching agents corresponding to the coloring compounds, and respective photothermal conversion materials that absorb light in different wavelength regions to generate heat. The recording layer 32 may be formed, for example, by dispersing the above-described microcapsules 32C, 32M, and 32Y in a macromolecular material exemplified as the constituent material of the above-described second layer 14 and applying the resultant dispersion onto the support base 11. It is to be noted that, for example, the material that configures the above-described heat-insulating layers 24 and 25 is preferably used as the microcapsule that incorporates the above-described materials.

### 3-2. Modification Example 2

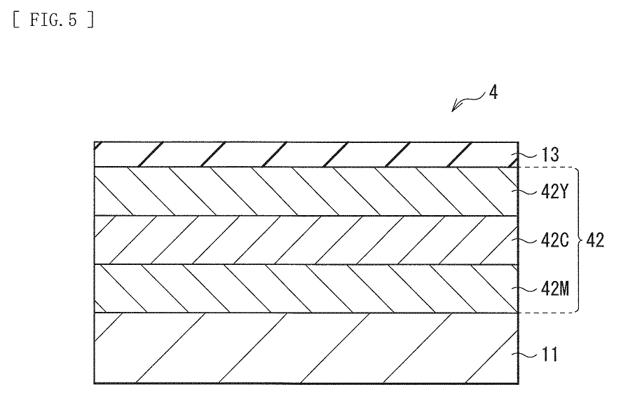

FIG. 5 illustrates a cross-sectional configuration of a reversible recording medium (a reversible recording medium 4) according to Modification Example 2 of the present disclosure. The reversible recording medium 4 is a modification example of the foregoing second embodiment. Similarly to the reversible recording medium 2 in the second embodiment, a recording layer 42 has a configuration in which a plurality of layers (a first layer to an n-th layer) are stacked. In the present modification example, the reversible recording medium 4 has a configuration in which the recording layer 42 (layers 42M, 42C, and 42Y) to be colored in different colors in color-developed states have different color-developing sensitivities and are stacked in the order of lower color-developing sensitivity in order from side of the support base 11, for example. It is to be noted that FIG. 5 schematically illustrates the cross-sectional configuration of the reversible recording medium 4 and that the size and shape thereof may be different from the actual size and shape thereof in some cases. Further, a stacking order of the layers 42M, 42C, and 42Y that configure the recording layer 42 of the present embodiment is exemplary, and is not limited to the above-described stacking order.

### (3-2-1. Configuration of Reversible Recording Medium)

Similarly to the second embodiment, the layers 42M, 42C, and 42Y include respective coloring compounds having different color hues, color developing/quenching agents corresponding to the respective coloring compounds, and photothermal conversion materials that absorb light in predetermined wavelength regions of a near infrared region, for example, to generate heat; the layers 42M, 42C, and 42Y are each formed by a macromolecular material, for example.

As described above, the reversible recording medium 4 has a configuration in which the recording layer 42 (the layers 42M, 42C, and 42Y) to be colored in different colors in color-developed states are stacked in the order of lower color-developing sensitivity in order from the side of the support base 11, for example. In other words, the reversible recording medium 4 of the present modification example has a configuration in which the recording layer 42 (the layers 42M, 42C, and 42Y) to be colored in different colors in color-developed states are stacked to have lower color-developing sensitivity in order from side of a laser irradiation surface in a case where laser irradiation is performed from side opposite to the support base 11, for example. That is, in the reversible recording medium 4 in which the layers 42M, 42C, and 42Y are stacked in this order from the side of the support base 11, the layer 42Y has the highest color-developing sensitivity, and the layer 42M has the lowest color-developing sensitivity.

Laser power required for color development varies depending on, for example, a melting point of a color developing/quenching agent, i.e., stability of crystals of the color developing/quenching agent. In general, the color developing/quenching agent has sensitivity that is lowered as alkyl chain length in a molecule becomes longer. For example, even in a layer including the same amount of a photothermal conversion material, laser power that is necessary to exhibit the same color density becomes larger as the alkyl chain length of the color developing/quenching agent becomes longer. That is, in the present modification example, respective color developing/quenching agents having different alkyl chain lengths in a molecule are added to the layer 42M, the layer 42C, and the layer 42Y; the length of the alkyl chain length becomes longer in the order of the layer 42Y, the layer 42C, and the layer 42M. This causes the color-developing sensitivity of each of the layer 42M, the layer 42C, and the layer 42Y to be lower in the order of the layer 42Y, the layer 42C, and the layer 42M.

It is to be noted that, as a method of changing the color-developing sensitivity of each of the layers 42M, 42C, and 42Y, a concentration of a sensitizer to be added to the layers 42M, 42C, and 42Y may be changed, instead of using the color developing/quenching agents having different alkyl chain lengths in a molecule as described above. Specifically, it is preferable to raise the concentration of the sensitizer in the order of the layers 42M, 42C, and 42Y. This causes the color-developing sensitivity to be higher in the order of the layers 42M, 42C, and 42Y.

The sensitizer lowers a color-developing temperature of the recording layer 42 (the layers 42M, 42C, and 42Y), and is a compound having a low melting point. In the recording layer 42 (the layers 42M, 42C, and 42Y), an effect of eutectic point between the sensitizer and the color developing/quenching agent allows for lowering of a color-developing temperature of a leuco pigment, thus enhancing the color-developing sensitivity. Examples of the sensitizer include a higher fatty acid amides such as a stearic acid amide, 1,2-bis(3-methylphenoxy)ethane, benzyloxy naphthalene, 1,2-diphenoxyethane, diphenyl sulfone, and p-terphenyl. It is to be noted that the sensitizer is not limited to the compounds listed above; any compound having the above-described function of the sensitizer may be adopted.

### (3-2-2 Workings and Effects)

As for the reversible recording medium having the recording layers 42 (the layers 42M, 42C, and 42Y) to be colored in different colors in the color-developed states, when each layer of the recording layers 42 (the layers 42M, 42C, and 42Y) are individually caused to develop a color together with the photothermal conversion materials by irradiation using lasers corresponding thereto, there is a possibility that color mixture may occur. This occurrence is caused by heat generation due to light absorption by a layer other than a desired layer or caused by propagation of heat generated due to the color-developing property. Specifically, in the reversible recording medium in which, for example, a yellow layer, a cyan layer, and a magenta layer are stacked in this order from the side of the laser irradiation surface in order, when irradiation is performed using a laser with 800 nm, for example, upon drawing in the yellow layer, for example, light transmitted without being absorbed by the yellow layer is absorbed by a skirt of a spectrum to be absorbed by the photothermal conversion material included in the cyan layer to cause the cyan layer to develop a color, thereby causing occurrence of color mixture.

In contrast, in the present modification example, each of the layer 42M, the layer 42C, and the layer 42Y that are stacked on the support base 11 in the order of the layers 42M, 42C, and 42Y has the color-developing sensitivity that is set to be higher in this order. This allows for suppression of color development of an underlayer (e.g., the layer 42C) due to laser light transmitted without being absorbed by the layer 42Y upon drawing of the layer 42Y. That is, it becomes possible to reduce occurrence of the color mixture.

It is to be noted that, although the color-developing sensitivity of each of the layer 42M, the layer 42C, and the layer 42Y may be adjusted by adopting one of use of the color developing/quenching agents having different alkyl chain lengths and amount of addition of the sensitizer, both of them may be combined to perform the adjustment.

Further, in a case where a difference in the color-developing sensitivity among the recording layer 42 (the layers 42M, 42C, and 42Y) is achieved by adding the color developing/quenching agents having different alkyl chain lengths, the configuration of the present modification example may be confirmed by laser irradiation, for example. Furthermore, in a case where a difference in the color-developing sensitivity among the recording layer 42 (the layers 42M, 42C, and 42Y) is achieved by adding the sensitizer, the configuration of the present modification example may be confirmed by specifying sensitizers contained in the layers 42M, 42C, and 42Y.

### 4. Application Examples

Next, description is given of application examples of the reversible recording medium (the reversible recording media 1 to 4) described in the foregoing first and second embodiments and Modification Examples 1 and 2. However, a configuration of an electronic apparatus described below is merely exemplary, and the configuration may be varied appropriately. Any of the above-described reversible recording media 1 to 4 is applicable to a portion of various electronic apparatuses or various clothing accessories, e.g., a portion of clothing accessories such as a watch (wristwatch), a bag, clothes, a hat, glasses, and shoes, as a so-called wearable terminal; the type of the electronic apparatuses, etc. is not particularly limited. In addition, it is also possible to apply, not only to the electronic apparatuses or the clothing accessories, but also to, as an exterior member, an interior or an exterior such as a wall, etc. of a building, an exterior of furniture such as a desk, and the like.

### Application Example 1

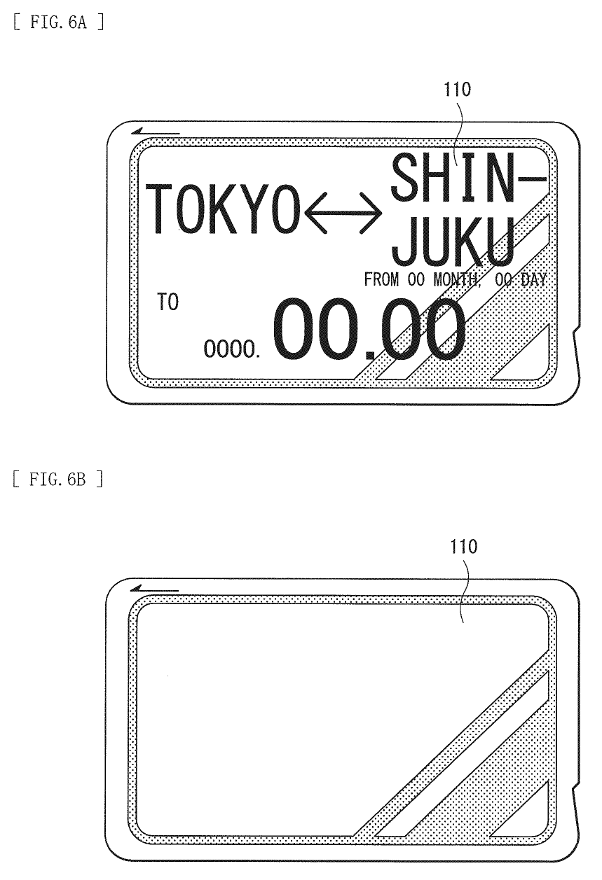

FIGS. 6A and 6B each illustrate an appearance of an integrated circuit (IC) card with a rewritable function. The IC card has a card surface that serves as a printing surface 110, and includes, for example, a sheet-shaped reversible recording medium 1, etc. that is adhered thereto. The IC card allows for drawing on the printing surface 110 as well as rewriting and deletion thereof appropriately by disposing the reversible recording medium 1, etc. on the printing surface 110, as illustrated in FIGS. 6A and 6B.

### Application Example 2

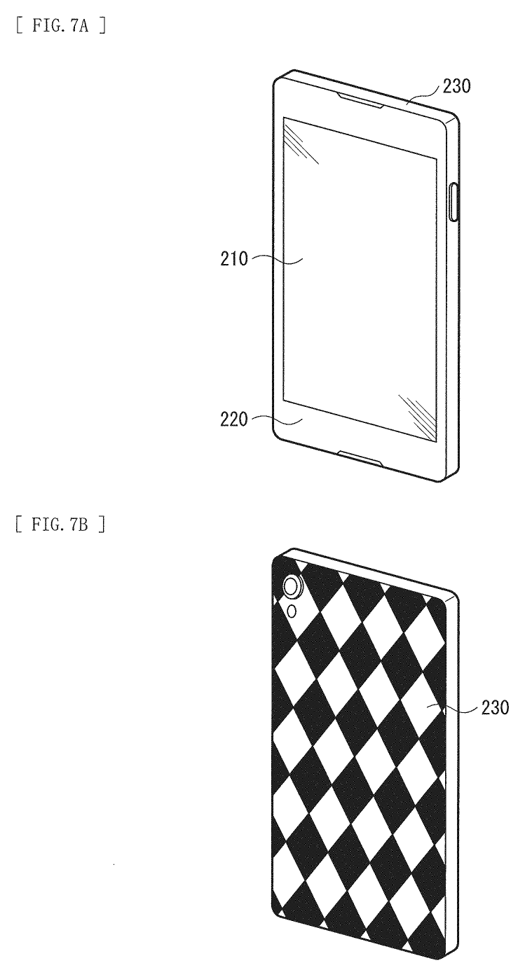

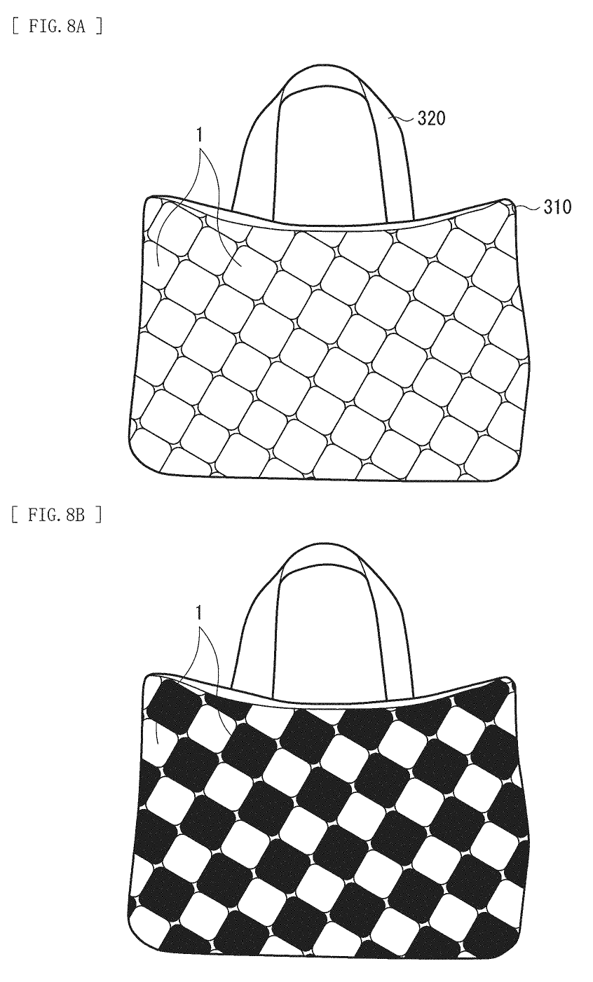

FIG. 7A illustrates a configuration of an appearance of a front surface of a smartphone, and FIG. 7B illustrates a configuration of an appearance of a rear surface of the smartphone illustrated in FIG. 7A. The smartphone includes, for example, a display part 210, a non-display part 220, and a casing 230. An entire surface, for example, of the casing 230 on side of the rear surface is provided with, for example, the reversible recording medium 1, etc. as the exterior member of the casing 230. This allows for display of various color patterns as illustrated in FIG. 7B. It is to be noted that, although the smartphone is exemplified here, this is not limitative; it is also possible to apply, for example, to a notebook personal computer (PC), a tablet PC, or the like.

### Application Example 3

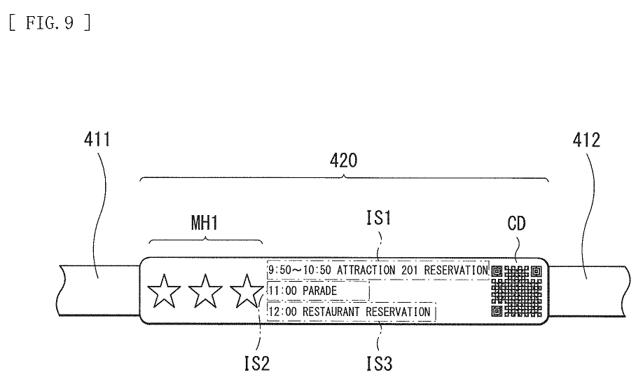

FIGS. 8A and 8B each illustrate an appearance of a bag. The bag includes a storing part 310 and a handle 320, for example, and the reversible recording medium 1, for example, is attached to the storing part 310. Various letters and patterns are displayed on the storing part 310 by means of the reversible recording medium 1, for example. The attachment of the reversible recording medium 1, etc. to a part of the handle 320 allows for display of various color patterns, and allows for change in design of the storing part 310, as illustrated, from the example of FIG. 8A to the example of FIG. 8B. It is also possible, for the purpose of fashion, to achieve a useful electronic device.

### Application Example 4

FIG. 9 illustrates a configuration example of a wristband able to record, in an amusement park, attraction-riding history, schedule information, and the like, for example. The wristband includes belt parts 411 and 412 and an information recording part 420. The belt parts 411 and 412 have a band shape, for example, and respective ends (unillustrated) thereof are configured to be connectable to each other. The reversible recording medium 1, etc., for example, is adhered to the information recording part 420, and attraction-riding history MH2 and schedule information IS (IS1 to IS3) as described above and an information code CD, for example, are recorded. In the amusement park, a visitor is able to record the above-described information by waving the wristband over a drawing apparatus installed at every location of attraction-riding reservation spots.

A riding history mark MH1 indicates the number of attractions ridden by a visitor who wears the wristband in the amusement park. In this example, as the visitor rides the more attractions, the more star-shaped marks are recorded as the riding history mark MH1. It is to be noted that this is not limitative; for example, the color of the mark may be changed in accordance with the number of attractions ridden by the visitor.

The schedule information IS in this example indicates a schedule of the visitor. In this example, information about all of events including an event reserved by the visitor and an event to be held in the amusement park is recorded as the schedule information IS1 to IS3. Specifically, in this example, a title of an attraction (an attraction 201) of which riding reserved by the visitor and scheduled time of the riding are recorded as the schedule information IS1. Further, an event such as a parade in the park and its scheduled starting time are recorded as the schedule information IS2. Furthermore, a restaurant reserved beforehand by a visitor 5 and its scheduled mealtime are recorded as the schedule information IS3.

The information code CD records, for example, identification information IID that is used to identify the wristband and website information IWS.

### 5. Working Examples

Next, description is given in detail of Working Examples of the present disclosure.

Five types of reversible recording media (Experimental Examples 1 to 5) each having the configuration exemplified in the foregoing second embodiment were produced as samples to evaluate their respective color differences ΔE* and chroma differences ΔC*.

### Experimental Example 1

A white polyethylene terephthalate substrate having a thickness of 1.88 mm was first provided as a support substrate. Subsequently, 0.23 g of a leuco pigment (RED-DCF) represented by the following formula (3), 0.4 g of a color developing/quenching agent (alkyl salicylate) represented by the following formula (4), 0.01 g of a phthalocyanine-based photothermal conversion material A, and 0.8 g of a polymer (MB1008, poly(vinyl chloride-co-vinyl acetate (9:1))) were added to 8.8 g of a solvent (methyl ethyl ketone (MEK)), and the resultant was dispersed for 2 hours using a rocking mill to prepare a homogeneous dispersion liquid (coating A). The coating A was applied onto the support substrate using a wire bar, and was subjected to heating and drying treatments at 70° C. for 5 minutes to form a magenta layer having a thickness of 3 μm. The photothermal conversion material included in the magenta layer had an absorbance of 0.16 for light of a wavelength of 920 nm. The absorbance of the magenta layer was determined by performing integrating sphere measurement using an ultraviolet-visible near infrared spectrophotometer V-770 (available from JASCO Corporation) on the magenta layer formed on a transparent polyethylene terephthalate substrate having a thickness of 50 m and by subtracting absorption by the substrate, etc.

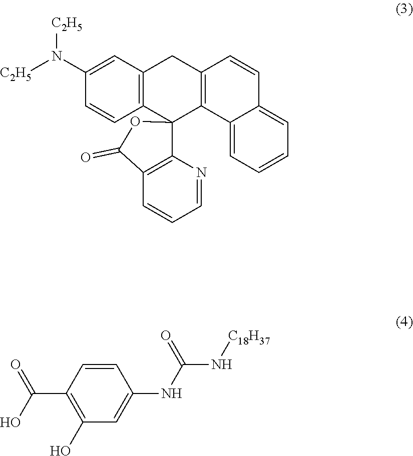

Subsequently, an aqueous polyvinyl alcohol solution was applied onto the magenta layer, and the resultant was dried to form a heat-insulating layer having a film thickness of 20 m.

Next, 0.2 g of a leuco pigment (H3035) represented by the following formula (5), 0.4 g of the color developing/quenching agent (alkyl salicylate) represented by the above formula (4), 0.01 g of a phthalocyanine-based photothermal conversion material B, and 0.8 g of the polymer (MB1008, poly(vinyl chloride-co-vinyl acetate (9:1))) were added to 8.8 g of the solvent (methyl ethyl ketone (MEK)), and the resultant was dispersed for 2 hours using a rocking mill to prepare a homogeneous dispersion liquid (coating B). The coating B was applied onto a support substrate using a wire bar, and was subjected to heating and drying treatments at 70° C. for 5 minutes to form a cyan layer having a thickness of 3 m. A method similar to that as described above was used to measure absorbance of the photothermal conversion material included in the cyan layer for light of a wavelength of 860 nm to find that a value of the absorbance was 0.2.

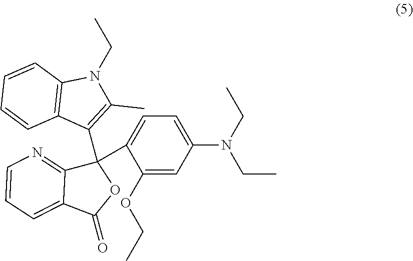 [SMILES: CCOc1cc(N(CC)CC)ccc1C1(c2c(C)n(CC)c3ccccc23)OC(=O)c2cccnc21]

Subsequently, an aqueous polyvinyl alcohol solution was applied onto the cyan layer, and the resultant was dried to form a heat-insulating layer having a film thickness of 20 μm.

Next, 0.15 g of a leuco pigment (TPY-7) represented by the following formula (6), 0.4 g of the color developing/quenching agent (alkyl salicylate) represented by the above formula (4), 0.01 g of a phthalocyanine-based photothermal conversion material C, and 0.8 g of the polymer (MB1008, poly(vinyl chloride-co-vinyl acetate (9:1))) were added to 8.8 g of the solvent (methyl ethyl ketone (MEK)), and the resultant was dispersed for 2 hours using a rocking mill to prepare a homogeneous dispersion liquid (coating C). The coating C was applied onto a support substrate using a wire bar, and was subjected to heating and drying treatments at 70° C. for 5 minutes to form a yellow layer having a thickness of 5 μm. A method similar to that as described above was used to measure absorbance of the photothermal conversion material included in the yellow layer for light of a wavelength of 760 nm to find that a value of the absorbance was 0.22.

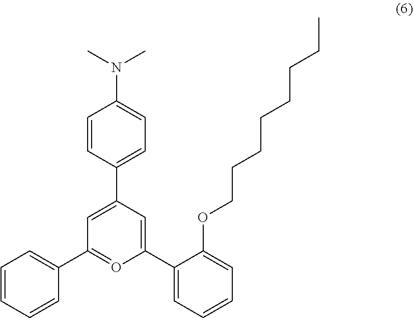

Lastly, an ultraviolet curable resin was used on the cyan layer to form a protective layer having a thickness of about 2 μm, thus producing a reversible multicolor recording medium (Experimental Example 1).

### Experimental Example 2

In Experimental Example 2, the photothermal conversion materials used for the magenta layer, the cyan layer, and the yellow layer were changed, respectively, to a cyanine-based photothermal conversion material D (0.003 g), a cyanine-based photothermal conversion material E (0.005 g), and a cyanine-based photothermal conversion material F (0.005 g). Except for the above change, a method similar to that of Experimental Example 1 was used to produce a reversible multicolor recording medium (Experimental Example 2).

### Experimental Example 3

In Experimental Example 3, the photothermal conversion materials used for the magenta layer were changed, respectively, to a cyanine-based photothermal conversion material G (0.003 g), a cyanine-based photothermal conversion material H (0.005 g), and the cyanine-based photothermal conversion material F (0.005 g). Except for the above change, a method similar to that of Experimental Example 1 was used to produce a reversible multicolor recording medium (Experimental Example 3).

### Experimental Example 4

In Experimental Example 4, ITO (0.17 g) was used as the photothermal conversion material in the magenta layer; except for this, a method similar to that of Experimental Example 1 was used to produce a reversible multicolor recording medium (Experimental Example 4).

### Experimental Example 5

In Experimental Example 5, a naphthalocyanine-based photothermal conversion material (0.01 g) was used as the photothermal conversion material in the cyan layer; except for this, a method similar to that of Experimental Example 1 was used to produce a reversible multicolor recording medium (Experimental Example 5).

In each of Experimental Examples 1 to 5, L*a*b* values were measured. The L*a*b* values of the support substrate were as follows: L*=95, a*=0.15, and b*=−2; these values were used as references to determine the color difference ΔE* and the chroma difference ΔC* from the recording layers in Experimental Examples 1 to 5. It is to be noted that a measurement method and measurements conditions for the L*a*b* values are as follows. Table 2 lists results of each of Experimental Examples 1 to 5. It is to be noted that evaluations of the color difference ΔE* and the chroma difference ΔC* in each of Experimental Examples 1 to 5 were as follows: those undiscriminated by the naked eye were ranked A, whereas those discriminated by the naked eye were ranked B.

### (Measuring Method for L*a*b* Values)

Instrument used: Xrite eXact available from X-Rite Inc.

### (Measuring Conditions)

Illuminant (light source): D50

Viewing angle (standard observer): a view of 2°

Illumination condition: MO (tungsten lamp, without a filter)

Optical geometric condition for a measuring instrument: 45/0 (illumination angle/light acceptance angle: relative to a surface of a sample from a normal direction)

### (Measuring Method)

An arbitrary location of each of samples (Experimental Examples 1 to 5) was measured five times or more to adopt an average value thereof as a “measured value”.

TABLE 2

| | | | | | | Chroma | Color |
|---|---|---|---|---|---|---|---|
| | | | | | | Differ- | Differ- |
| | | | | | | ence | ence |
| | | | | Chroma | Color | from | from |
| | | | | Differ- | Differ- | Support | Support |
| | | | | ence | ence | Sub- | Sub- |
| | L* | a* | b* | (ΔC*) | (ΔE*) | strate | strate |
| Experimental | 82.1 | −0.8 | −1.9 | 2.0 | 14.3 | A | B |
| Example 1 | | | | | | | |
| Experimental | 87.1 | 1.5 | −1.5 | 2.1 | 9.3 | A | B |
| Example 2 | | | | | | | |
| Experimental | 89.0 | 0.6 | 0.3 | 2.3 | 6.4 | A | A |
| Example 3 | | | | | | | |
| Experimental | 91.8 | −0.4 | −1.7 | 0.6 | 3.2 | A | A |
| Example 4 | | | | | | | |
| Experimental | 82.1 | −3.4 | 6.4 | 9.0 | 15.8 | B | B |
| Example 5 | | | | | | | |

Table 2 indicates that, in Experimental Examples 1 to 5, the color difference ΔE* and the chroma difference ΔC* in Experimental Example 4 are the smallest. That is, it was appreciated that the recording layer produced in Experimental Example 4 was able to exhibit a color of the support substrate itself the most in a deleted state. One reason for this is that ITO, the photothermal conversion material used in Experimental Example 4, has a larger L* value than that of the photothermal conversion material (the phthalocyanine-based photothermal conversion material A) in Experimental Example 1. In Experimental Example 1 and Experimental Example 4, density of each of the phthalocyanine-based photothermal conversion material A and ITO included in the magenta layer in Experimental Example 1 and Experimental Example 4 is adjusted to satisfy ΔC*≤3.2. It is thus presumed that a difference in the L* value leads to a difference in ΔE*. It is to be noted that L* denotes lightness, and indicates, in the present embodiment, how less reflected light of the white support substrate is blocked, i.e., transmittance of the recording layer. Accordingly, in Experimental Example 4, the use of the photothermal conversion material having large L* for formation of the magenta layer enhanced transparency of the entire recording layer. Thus, it becomes possible to recognize the support substrate more clearly than Experimental Example 1 and other Experimental Examples, thus enabling the color difference to be felt smaller. This appears in ΔE*≤3.2.

It is to be noted that the L*a*b* values in accordance with an instrument available from another company may be measured, for example, using the following method. First, a coating surface (recording layer) was removed by detachment, cleavage, dissolution, or the like, and L*a*b* values of only a casing are measured. Next, L*a*b* values of only the coating surface obtained from the casing by detachment, cleavage, cutting of the casing, or the like are measured. At this occasion, the coating surface is fixed onto a substrate having a transmittance of 90%, and the substrate is placed on the white plate (described above) to perform the measurement. Lastly, ΔC* and ΔE* are calculated from the respective L*a*b* values of the coating surface and the casing.

Although the present disclosure has been described above with reference to the first and second embodiments, Modification Examples 1 and 2, and Working Examples, the present disclosure is not limited to aspects described in the foregoing embodiments, etc., and may be modified in a variety of ways. For example, not all the components described in the foregoing embodiments, etc. may necessarily be provided, and any other component may be further included. Moreover, the materials and the thicknesses of the above-described components are merely examples, and are not limited to those described herein.

Further, although the foregoing modification example gives an example where the microcapsule is used to perform full-color display in the single-layer structure, this is not limitative; for example, it is also possible to use a fiber-shaped three-dimensional stereoscopic structure to perform the full-color display. For example, the fiber to be used here preferably has a so-called core-sheath structure configured by a core part that includes the coloring compound to be colored in a desired color, the color developing/quenching agent corresponding thereto, and the photothermal conversion material, and by a sheath part that coats the core part and is configured by a heat-insulating material. By forming the three-dimensional stereoscopic structure using a plurality of types of fibers having the core-sheath structure and including respective coloring compounds to be colored in different colors, it becomes possible to produce a reversible recording medium that enables full-color display.

Furthermore, although the foregoing embodiments, etc. give an example where the laser is used to perform color development and decoloring of recording layers, this is not limitative. For example, a thermal head may also be used to perform the color development and the decoloring.

It is to be noted that the effects described in the present specification are merely exemplary and not limitative, and may have other effects.

It is to be noted that the present disclosure may have the following configurations.

[1]

A reversible recording medium including:

a support base; and

a recording layer provided on the support base and reversibly changing between a recorded state and a deleted state,

a chroma difference ΔC* between the support base and the recording layer in the deleted state satisfying the following relational expression (1):

ΔC*=√((a₀*−aₛ*)²+(b₀*−bₛ*)²)≤6.5 (1)

where

an absorption spectrum in a visible region of the recording layer in the deleted state is denoted by Lₛ*aₛ*bₛ*, and

an absorption spectrum in a visible region of the support base is denoted by L₀*a₀*b₀*.

[2]

The reversible recording medium according to [1], in which a color difference ΔE* between the support base and the recording layer in the deleted state satisfies the following relational expression (2):

ΔE*=√((L₀*−Lₛ*)²+(a₀*−aₛ)²+(b₀*−bₛ*)²)≤6.5 (2).

[3]

The reversible recording medium according to [1] or [2], in which the recording layer includes

a coloring compound having an electron-donating property,

a color developing/quenching agent having an electron-donating property,

a photothermal conversion material that absorbs a wavelength in a near infrared region to generate heat, and

a matrix resin.

[4]

The reversible recording medium according to any one of [1] to [3], in which the chroma difference ΔC* between the support base and the recording layer in the deleted state further satisfies the following relational expression (3):

ΔC*=√((a₀*−aₛ*)²+(b₀*−bₛ*)²)≤3.2 (3).

[5]

The reversible recording medium according to any one of [1] to [4], in which a color difference ΔE* between the support base and the recording layer in the deleted state further satisfies the following relational expression (5):

ΔE*=√((L₀*−Lₛ*)²+(a₀*−aₛ)²+(b₀*−bₛ*)²)≤3.2 (4).

[6]

The reversible recording medium according to any one of [3] to [5], in which the recording layer includes a first layer to an n-th layer that include the respective coloring compounds having different developed color hues, the first layer to the n-th layer being stacked in this order on the support base.

[7]

The reversible recording medium according to [6], in which the first layer to the n-th layer include the respective photothermal conversion materials that absorb wavelengths in near infrared regions of different wavelength regions to generate heat.

[8]

The reversible recording medium according to [6] or [7], in which the recording layer includes, between corresponding layers of the first layer to the n-th layer, an intermediate layer that includes a matrix resin different from the matrix resin included in the recording layer.

[9]

The reversible recording medium according to any one of [3] to [8], in which the photothermal conversion material includes one of a derivative having one of a cyanine skeleton, a phthalocyanine skeleton, a naphthalocyanine skeleton, a squarylium skeleton, and a croconium skeleton, an iminium salt, an aminium salt, a thiolate complex, and an inorganic compound.

[10]

The reversible recording medium according to any one of [3] to [9], in which the photothermal conversion material has an absorption peak in a range from 700 nm to 2,000 nm.

[11]

The reversible recording medium according to any one of [3] to [10]], in which the recording layer includes the first layer to the n-th layer that include the respective coloring compounds having different developed color hues, the first layer to the n-th layer having different color-developing sensitivities.

[12]

The reversible recording medium according to [11], in which

the first layer to the n-th layer are stacked in this order from side of a laser irradiation surface, and

the color-developing sensitivities of the first layer to the n-th layer become lower in order from the side of the laser irradiation surface.

[13]

The reversible recording medium according to [11] or [12], in which the color developing/quenching agents having different alkyl chain lengths are added to corresponding ones of the first layer to the n-th layer.

[14]

The reversible recording medium according to any one of [11] to [13], in which

the first layer to the n-th layer include respective sensitizers, and

contained amounts of the sensitizers are different from one another.

[15]

The reversible recording medium according to any one of [1] to [14], in which the support base includes a member having light-transmissivity or light reflectivity in the visible region.

[16]

The reversible recording medium according to any one of [1] to [15], in which a protective layer is provided on the recording layer.

[17]

An exterior member having at least one surface provided with a reversible recording medium,

the reversible recording medium including:

a support base; and

a recording layer provided on the support base and reversibly changing between a recorded state and a deleted state,

a chroma difference ΔC* between the support base and the recording layer satisfying the following relational expression (1):

ΔC*=((a₀*−aₛ*)²+(b₀*−bₛ*)²)≤6.5 (1)

where

an absorption spectrum in a visible region of the recording layer in the deleted state and an absorption spectrum in a visible region of the support base are each denoted by L*a*b*.

This application claims the benefit of Japanese Priority Patent Application JP2016-225356 filed with the Japan Patent Office on Nov. 18, 2016, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A reversible recording medium comprising:
a support base; and
a recording layer provided on the support base and reversibly changing between a recorded state and a deleted state,
a chroma difference ΔC* between the support base and the recording layer in the deleted state satisfying the following relational expression (1):
ΔC*=((a₀*−aₛ*)²+(b₀*−bₛ*)²)≤6.5 (1)
where
an absorption spectrum in a visible region of the recording layer in the deleted state is denoted by Lₛ*aₛ*bₛ*, and
an absorption spectrum in a visible region of the support base is denoted by L₀*a₀*b₀*.

2. The reversible recording medium according to claim 1, wherein a color difference ΔE* between the support base and the recording layer in the deleted state satisfies the following relational expression (2):
ΔE*=√((L₀*−Lₛ*)²+(a₀*−aₛ)²+(b₀*−bₛ*)²)≤6.5 (2).

3. The reversible recording medium according to claim 1, wherein the recording layer includes
a coloring compound having an electron-donating property,
a color developing/quenching agent having an electron-donating property,
a photothermal conversion material that absorbs a wavelength in a near infrared region to generate heat, and
a matrix resin.

4. The reversible recording medium according to claim 1, wherein the chroma difference ΔC* between the support base and the recording layer in the deleted state further satisfies the following relational expression (3):
ΔC*=√((a₀*−aₛ*)²+(b₀*−bₛ*)²)≤3.2 (3).

5. The reversible recording medium according to claim 1, wherein a color difference ΔE* between the support base and the recording layer in the deleted state further satisfies the following relational expression (5):
ΔE*=√((L₀*−Lₛ*)²+(a₀*−aₛ)²+(b₀*−bₛ*)²)≤3.2 (4).

6. The reversible recording medium according to claim 3, wherein the recording layer includes a first layer to an n-th layer that include the respective coloring compounds having different developed color hues, the first layer to the n-th layer being stacked in this order on the support base.

7. The reversible recording medium according to claim 6, wherein the first layer to the n-th layer include the respective photothermal conversion materials that absorb wavelengths in near infrared regions of different wavelength regions to generate heat.

8. The reversible recording medium according to claim 6, wherein the recording layer includes, between corresponding layers of the first layer to the n-th layer, an intermediate layer that includes a matrix resin different from the matrix resin included in the recording layer.

9. The reversible recording medium according to claim 3, wherein the photothermal conversion material comprises one of a derivative having one of a cyanine skeleton, a phthalocyanine skeleton, a naphthalocyanine skeleton, a squarylium skeleton, and a croconium skeleton, an iminium salt, an aminium salt, a thiolate complex, and an inorganic compound.

10. The reversible recording medium according to claim 3, wherein the photothermal conversion material has an absorption peak in a range from 700 nm to 2,000 nm.

11. The reversible recording medium according to claim 3, wherein the recording layer includes a first layer to an n-th layer that include the respective coloring compounds having different developed color hues, the first layer to the n-th layer having different color-developing sensitivities.

12. The reversible recording medium according to claim 11, wherein
the first layer to the n-th layer are stacked in this order from side of a laser irradiation surface, and
the color-developing sensitivities of the first layer to the n-th layer become lower in order from the side of the laser irradiation surface.

13. The reversible recording medium according to claim 11, wherein the color developing/quenching agents having different alkyl chain lengths are added to corresponding ones of the first layer to the n-th layer.

14. The reversible recording medium according to claim 11, wherein
the first layer to the n-th layer include respective sensitizers, and
contained amounts of the sensitizers are different from one another.

15. The reversible recording medium according to claim 1, wherein the support base comprises a member having light-transmissivity or light reflectivity in the visible region.

16. The reversible recording medium according to claim 1, wherein a protective layer is provided on the recording layer.

17. An exterior member having at least one surface provided with a reversible recording medium,
the reversible recording medium comprising:
a support base; and
a recording layer provided on the support base and reversibly changing between a recorded state and a deleted state,
a chroma difference ΔC* between the support base and the recording layer satisfying the following relational expression (1):
ΔC*=√((a₀*−aₛ*)²+(b₀*−bₛ*)²)≤6.5 (1)
where
an absorption spectrum in a visible region of the recording layer in the deleted state and an absorption spectrum in a visible region of the support base are each denoted by L*a*b*.
